(19) United States
(12) Patent Application Publication
(10) Pub. No.: US 2007/0157685 A1
(43) Pub. Date: Jul. 12, 2007

(54) MECHANICAL ACCESS IDENTIFIER

(76) Inventor: Vitaly Bardachenko, Kiev (UA)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/465,292

(22) Filed: Aug. 17, 2006

Related U.S. Application Data
(63) Continuation-in-part of application No. 10/471,633, filed on Sep. 12, 2003, now abandoned.

(30) Foreign Application Priority Data
Nov. 7, 2001 (UA) 2001074869

(51) Int. Cl. E05B 19/18

(52) U.S. Cl. 70/411

(57) ABSTRACT

An apparatus includes a handle and a rod coupled to the handle. A plurality of plates are coupled to the rod. Each plate from the plurality of plates defines an opening. Each plate from the plurality of plates configured to be rotatably movable with respect to the rod and linearly movable in an orthogonal direction with respect to a longitudinal axis defined by the rod. The plurality of plates being collectively reconfigurable to a predetermined configuration in which the plurality of plates collectively mate with a controller.

### CROSS-REFERENCE TO RELATED APPLICATIONS

This application is a continuation-in-part of U.S. patent application Ser. No. 10/471,633, entitled “Mechanical Access Identifier,” filed on Sep. 12, 2003, which is a 371 of PCT/UA02/00028, entitled “Bardatchenko Method for Identifying Access Rights to Objects and to Code Information Input,” filed Jul. 10, 2002, each of which is incorporated herein by reference in its entirety.

### BACKGROUND

The invention relates generally to an identifier, and more particularly to an identifier that identifies access rights to a controller.

Identifiers and controllers are used to secure doors and equipment from access or usage by unauthorized persons. The typical identifier presents a code to a controller. If the controller recognizes the code that is presented by the identifier, then the user is granted access rights.

Known identifiers that control user access rights by mechanical means include a conventional key and lock, for example, a door lock and mating key. While such a key provides a simple means of controlling access rights to a controller or other objects, a typical key is permanently configured with only one code. Thus, to obtain user access rights to several different locks, a user must carry multiple keys, each key having a different code. If such a key is lost or stolen, a user may associate that key with its corresponding lock and the user may gain unauthorized access rights.

Other known identifiers or keys may be configured to be used with multiple controllers. Some include the use of reconfigurable magnetic elements, which requires a more complicated mating lock system. Another type of key uses plates having varying lengths. While such identifiers are configured to have multiple code permutations, that number can be limited and the identifier may be costly and difficult to replace if lost or stolen.

Thus, a need exists for an identifier that is simple and inexpensive to manufacture yet provides multiple code permutations.

### SUMMARY OF THE INVENTION

An apparatus includes a handle and a rod coupled to the handle. A plurality of plates are coupled to the rod. Each plate from the plurality of plates defines an opening. Each plate from the plurality of plates configured to be rotatably movable with respect to the rod and linearly movable in an orthogonal direction with respect to a longitudinal axis defined by the rod. The plurality of plates being collectively reconfigurable to a predetermined configuration in which the plurality of plates collectively mate with a controller.

### BRIEF DESCRIPTION OF THE DRAWINGS

The invention is described with reference to the accompanying drawings. In the drawings, like reference numbers indicate identical or functionally similar elements.

FIG. 1 is a side perspective view of an identifier, according to an embodiment of the invention shown with a portion in cut-away.

FIG. 2 is a side perspective view of the identifier shown in FIG. 1, shown with a plate rotated 90 degrees about an axis A.

FIGS. 3-6 are alternative sectional views taken along line 3-3 in FIG. 1.

FIG. 7 is a portion of an opening shown in FIG. 3.

### DETAILED DESCRIPTION

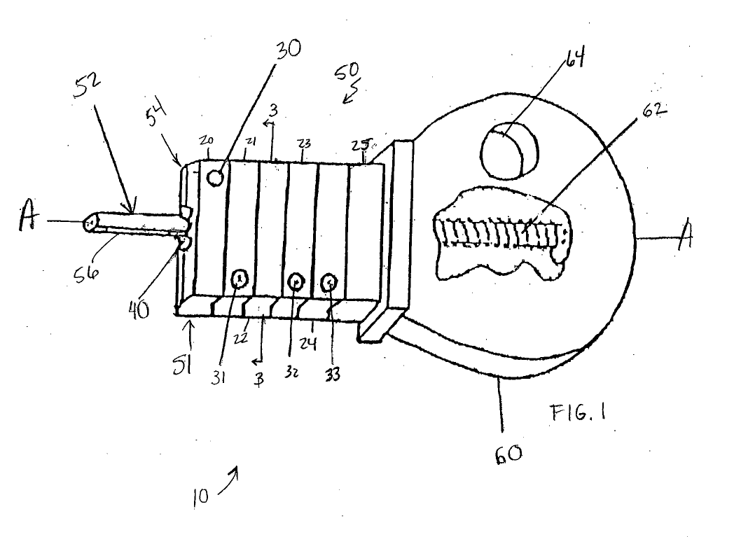

FIG. 1 illustrates an identifier 10 according to an embodiment of the invention. An identifier 10 includes a handle 60 and a code portion 50. The code portion 50 includes a rod 52 and a set of plates 54 coupled to the rod 52 In this embodiment, six plates are shown labeled 20, 21, 22, 23, 24, and 25. Each plate from the set of plates 54 can include one or more code marker 30. Each plate from the set of plates 54 can be configured to rotate with respect to the rod 52 about an axis A defined by the rod 52. In this embodiment, the plate 25 nearest the handle 60 is fixedly coupled to the handle 60 such that the plate 25 does not rotate about the rod 52.

The rod 52 is coupled to the handle 60 with a spring-loaded connection that includes a spring 62. The rod 52 is coupled to the handle 60 such that the rod 52 does not rotate about the axis A independently from the handle 60. The handle 60 can also include a key ring opening 64, that can be used to couple the identifier 10 to a key ring or other object.

The handle 60 is configured to switch the identifier 10 between an engaged state and a disengaged state to allow a user to set the input code on the code portion 50. When in an engaged or interlocked state, the handle 60 applies a pressure to retain the set of plates 54 in a stationary position on the rod 52. When in a disengaged state, the handle 60 does not apply an outward pressure, thereby allowing the plates 54 to move both linearly in an orthogonal direction with respect to the rod 52 and rotationally about a circumference of the rod 52.

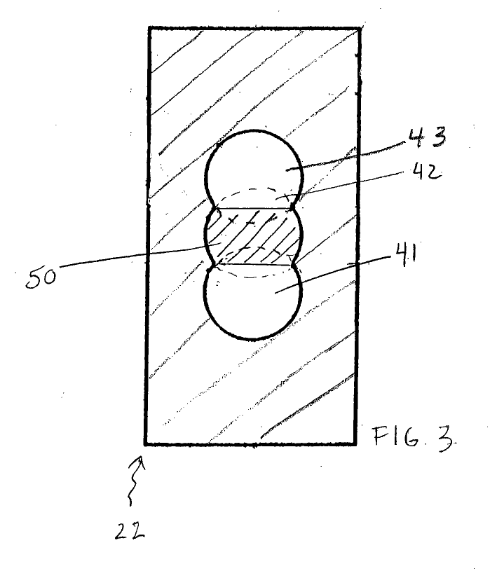

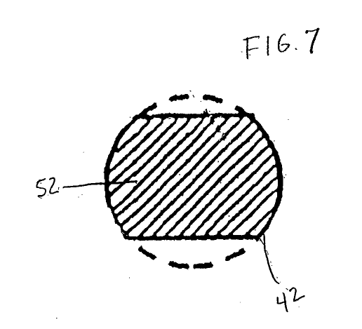

The plates 54 (20, 21, 22, 23, 24, 25) each include an opening 40 configured to receive the rod 52 therethrough. The rod 52 can include an end portion 56 that extends beyond the plates 54 (20, 21, 22, 23, 24, 25) and that is larger than the opening 40 to retain the plates 54 (20, 21, 22, 23, 24, 25) on the rod 52. As best shown in FIG. 3, the opening 40 can include three portions 41, 42, and 43, which in this embodiment are configured as three overlapping circular openings. Each of the portions 41, 42, and 43 are configured to engage the rod 52 in an interlocking position. FIG. 7 illustrates the rod 52 engaged within portion 42 of opening 40.

The identifier 10 is reconfigurable such that a user can selectively rotate one or more of the plates 54 (20, 21, 22, 23, 24, 25) of the code portion 50, and/or the handle 60, to configure the identifier 10 with an input code. The input code can vary depending on the rotational position of the plates 54 (20, 21, 22, 23, 24, 25) about the rod 52, the linear position of the plates 54 (20, 21, 22, 23, 24, 25) with respect to the rod 52, and the position of the code markers 30 (if any) on the plates 54 (20, 21, 22, 23, 24, 25). Thus, the identifier 10 can be reconfigured to many different combinations or input codes.

The identifier 10 can be configured with a specific input code that can be used to gain access to, for example, a controller (not shown). The controller can be, for example, a central locking system, or a door lock. The controller can be configured to detect a pre-determined input code such that when the identifier is inserted into the controller, the controller can detect whether the identifier has the correct pre-determined input code.

Thus, to gain access rights, a user inserts the identifier into the controller. If the identifier has been configured with the correct input code, the controller will mechanically respond to the input code and provide access to the user.

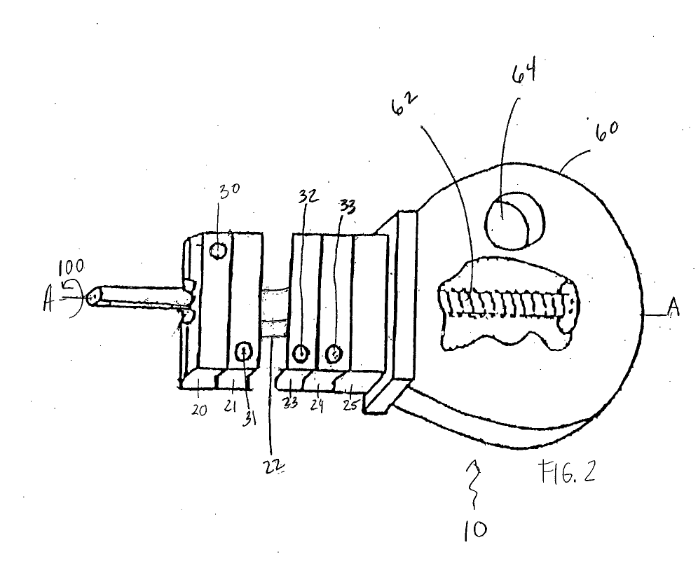

FIG. 2 illustrates the identifier 10 with the plate 22 rotated 90 degrees about the axis A. Thus, FIG. 2 illustrates the identifier 10 reconfigured with a different input code than that shown in FIG. 1 based on the positioning of the plates 54 (20, 21, 22, 23, 24, 25) and the position of the code markers 30 (31, 32, 33).

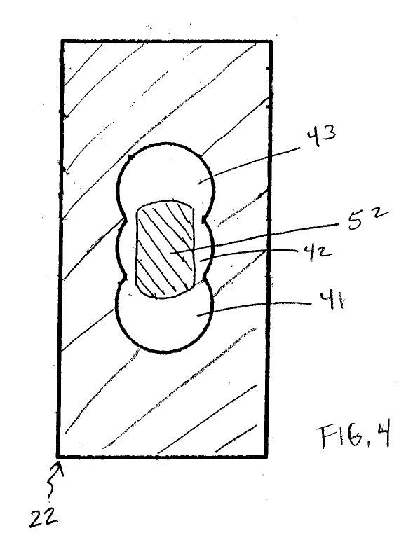

FIG. 3 is a sectional view of the identifier 10 taken along line 3-3 in FIG. 1 and illustrates one position of the rod 52. In this figure, the rod 52 is interlocked or engaged within the portion 42 of opening 40. In the engaged position, the plate 22 can be moved with respect to the rod 52 within the portion 42. The rod 52 can be disengaged from the interlocking position by rotating the handle of the identifier ninety degrees in either direction about the axis A, to reposition the rod 52 with respect to plate 22, as shown in FIG. 4. In this position, the rod 52 can be displaced in either direction along an axis B defined by the opening 40.

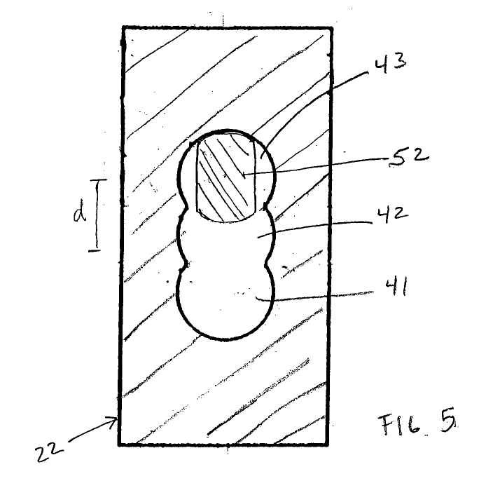

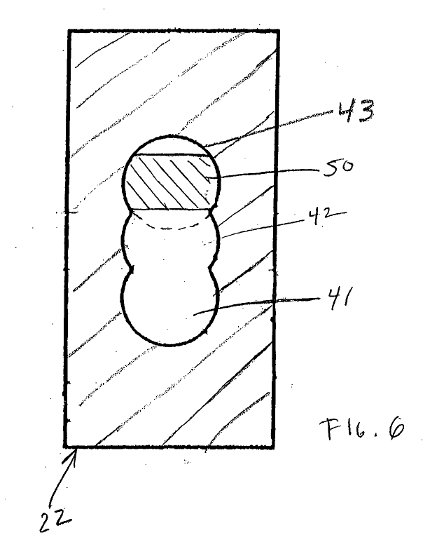

FIG. 5 shows the rod 52 displaced a distance d within the opening 40 along the axis B and disposed within the portion 43. To return the rod 52 to an interlocking or engaged position, as shown in FIG. 6, the handle 60 of the identifier 10 is rotated ninety degrees, which repositions rod 52 within portion 43.

### CONCLUSION

The previous description of the embodiment is provided to enable any person skilled in the art to make or use the invention. While the invention has been particularly shown and described with reference to embodiments thereof, it will be understood by those skilled in art that various changes in form and details may be made therein without departing from the spirit and scope of the invention. For example, the identifier may include more than one rod. Furthermore, the plate may include a plurality of passageways, or passageways configured to receive differently shaped rods. The plate may also include non-mechanical code markers, such as magnetic or optical code markers.

1. An apparatus, comprising:
a handle;
a rod coupled to the handle; and
a plurality of plates coupled to the rod, each plate from the plurality of plates defining an opening, each plate from the plurality of plates configured to be rotatably movable with respect to the rod and linearly movable in an orthogonal direction with respect to a longitudinal axis defined by the rod,
the plurality of plates being collectively reconfigurable to a predetermined configuration in which the plurality of plates collectively mate with a controller.

2. The apparatus of claim 1, wherein at least one plate from the plurality of plates includes a code marker configured to mechanically engage a portion of the controller.

3. The apparatus of claim 1, wherein the rod is coupled to the handle with a spring-loaded connection.

4. The apparatus of claim 1, wherein the rod is coupled to the handle with a spring-loaded connection configured to move the rod between a first configuration in which the rod is engaged with the opening of at least one plate from the plurality of plates and a second configuration in which the rod is configured to be movably disposed within the opening of at least one plate from the plurality of plates.

5. The apparatus of claim 1, wherein the handle includes an opening configured to couple the handle to an object.

6. An apparatus, comprising:
a code portion configured to mechanically engage a portion of a controller, the code portion including a rod and at least one plate movably coupled to the rod, the at least one plate defining an opening, the rod disposed within the opening, the at least one plate being configured to be selectively moved laterally in an orthogonal direction with respect to a longitudinal axis defined by the rod; and
a handle coupled to the code portion, the handle configured to move the rod from a first configuration in which the rod is engaged with the at least one plate within the opening of the at least one plate and a second configuration in which the rod is disengaged from the at least one plate.

7. The apparatus of claim 6, wherein the at least one plate is configured to rotatably move with respect to the longitudinal axis defined by the rod.

8. The apparatus of claim 6, wherein the opening includes a plurality of portions, the rod in the first configuration is engaged with one portion from the plurality of portions.

9. The apparatus of claim 6, wherein the at least one plate includes a code marker configured to matingly engage a portion of the controller.

10. The apparatus of claim 6, wherein the handle includes a hole configured to couple the apparatus to an object.
